(19) United States
(12) Patent Application Publication
(10) Pub. No.: US 2005/0010830 A1
(43) Pub. Date: Jan. 13, 2005

(54) Power reduction in microprocessor systems

(76) Inventor: Paul Webster, Cambridge (GB)

Correspondence Address: AT&T CORP., P.O. BOX 4110, MIDDLETOWN, NJ, 07748, US

(21) Appl. No.: 10/486,302

(22) PCT Filed: Aug. 8, 2002
(86) PCT No.: PCT/GB02/03650

(30) Foreign Application Priority Data
Aug. 10, 2001 (GB) 0119498.4

(51) Int. Cl. G06F 1/32; G06F 1/26

(52) U.S. Cl. 713/320

(57) ABSTRACT

A method is provided for reducing the power consumtion of a microprocessor system that comprises of a micro-processor and a memory connected by at least one bus. The method includes: determining the frequency with which each control code occurs, or is likely to occur, adjacent to each of the other control codes in consecutive instructions of a program, and based on the frequencies so determined, assigning a bit pattern to each control code which minimises the average Hamming distance between consecutive instructions when the program is run.

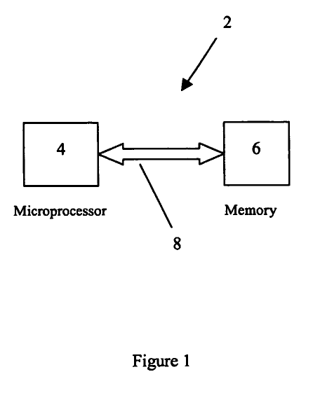

The invention relates to power reduction in microprocessor systems comprising a microprocessor and a memory connected by at least one bus.

The methods described in this specification aim to improve the processor's average inter-instruction Hamuning distance. The next few paragraphs describe this metric and explain its relation to power efficiency.

The Hamming distance between two binary numbers is the count of the number of bits that differ between them. For example:

| Numbers in | Numbers in binary | Hamming |
|---|---|---|
| decimal | (inc. leading zeros) | distance |
| 4 and 5 | 0100 and 0101 | 1 |
| 7 and 10 | 0111 and 1010 | 3 |
| 0 and 15 | 0000 and 1111 | 4 |

Hamming distance is related to power efficiency because of the way that binary numbers are represented by electrical signals. Typically a steady low voltage on a wire represents a binary 0 bit and a steady high voltage represents a binary 1 bit. A number will be represented using these voltage levels on a group of wires, with one wire per bit. Such a group of wires is called a bus. Energy is used when the voltage on a wire is changed. The amount of energy depends on the magnitude of the voltage change and the capacitance of the wire. The capacitance depends to a large extent on the physical dimensions of the wire. So when the number represented by a bus changes, the energy consumed depends on the number of bits that have changed—the Hamming distance—between the old and new values, and on the capacitance of the wires.

If one can reduce the average Hamming distance between successive values on a high-capacitance bus, keeping all other aspects of the system the same, the system's power efficiency will have been increased.

The capacitance of wires internal to an integrated circuit is small compared to the capacitance of wires fabricated on a printed circuit board due to the larger physical dimensions of the latter. Many systems have memory and microprocessor in distinct integrated circuits, interconnected by a printed circuit board. Therefore we aim to reduce the average Hamming distance between successive values on the microprocessor-memory interface bus, as this will have a particularly significant influence on power efficiency.

Even in systems where microprocessor and memory are incorporated into the same integrated circuit the capacitance of the wires connecting them will be larger than average, so even in this case reduction of average Hamming distance on the microprocessor-memory interface is worthwhile.

Processor-memory communications perform two tasks. Firstly, the processor fetches its program from the memory, one instruction at a time. Secondly, the data that the program is operating on is transferred back and forth. Instruction fetch makes up the majority of the processor-memory communications.

The instruction fetch bus is the bus on which instructions are communicated from the memory to the processor. We aim to reduce the average Hamming distance on this bus, i.e. to reduce the average Hamming distance from one instruction to the next.

Instruction formats will now be discussed.

A category of processors which is suitable for implementation of the invention is the category of RISC (Reduced Instruction Set Computer) processors. One defining characteristic of this category of processors is that they have regular, fixed-size instructions. In the example processor considered here all instructions are made up of 32 bits. This is the same as the size of the instruction fetch bus.

Each instruction needs to convey various items of information to the processor. These items include:
Operation codes (opcodes) indicating which basic action, such as addition, subtraction, etc. the processor should carry out.
Register specifiers, indicating which of the processor's internal storage locations (registers) should supply operands to or receive results from the operation.
Values that are used directly as operands to the function called immediate values.

For example, an instruction that tells the processor to “add 10 to the value currently in register 4 and store the result in register 5” would have the opcode for ‘add’, register specifiers 4 and 5, and immediate value 10.

The instruction set for the example processor considered here has only three instruction formats. The first has a five-bit opcode and a 26-bit immediate value. The second has a five-bit opcode, two five-bit register specifiers, and a 16-bit immediate value. The third has a five-bit primary opcode, a six bit secondary opcode and three five-bit register specifiers. The fields are arranged so that the primary opcode field is always in the same bit positions for each of the different formats:

| | | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|---|
| 31 | . | . | . | . | . | . | . | . | . | . | . | . | . | . | . | . | . | . | . | . | . | . | . | . | . | . | . | . | . | . | 0 |

| X | <Primary | <Immediate26> | | | | | | | | |
|---|---|---|---|---|---|---|---|---|---|---|
| | Opcode> | | | | | | | | | |
| X | <Primary | <Reg1> | <Reg2> | <Immediate16> | | | | | | |
| | Opcode> | | | | | | | | | |
| X | <Primary | <Reg1> | <Reg2> | X | X | X | X | X | <Secondary | <Reg3> |
| | Opcode> | | | | | | | | Opcode> | |

One embodiment of the invention seeks to reduce the average inter-instruction Hamming distance by assigning appropriate bit patterns to the opcodes.

The invention provides a method of reducing the power consumption of a microprocessor system, a program, and a reduced power microprocessor system, as set out in the accompanying claims.

Embodiments of the invention will now be described, by way of example only, with reference to the accompanying figure.

The accompanying figure shows a microprocessor system 2 suitable for implementation of the invention. The microprocessor system 2 comprises a microprocessor 4 connected to a memory 6 by a bus 8. The microprocessor 4 and memory 6 may of course be incorporated into the same integrated circuit.

Part of the design of an instruction set is the allocation of bit patterns to each opcode. An example of a set of opcodes and the corresponding bit patterns is shown in the table below:

| | Primary Opcode | Secondary Opcode |
|---|---|---|
| Opcode | Bit Pattern | Bit Pattern |
| ld.bu | 10000 | N/A |
| movhi | 00011 | N/A |
| andi | 01000 | N/A |
| rsubi | 11001 | N/A |
| mul | 00000 | 010111 |
| add | 00000 | 000100 |
| ldx.w | 00000 | 010100 |
| call | 11110 | N/A |

When examining the behaviour of programs it is observed that some pairs of opcodes tend to be executed consecutively more frequently than others. We can therefore arrange for the pairs of opcodes that are frequently consecutive to have bit patterns with small Hamming distances between them.

To achieve this, we need to measure how frequently each of the opcodes is executed consecutively to any of the other opcodes. We can measure this from running benchmark applications. When possible, these benchmarks should be the specific application that will be run by the processor, along with representative run-time data to operate on. For a general-purpose processor, a set of representative benchmarks can be chosen.

Initially, we will consider the primary opcode bit patterns because, in the example instruction set considered above, these have the benefit that they are only ever aligned with other primary opcode bit patterns.

From the benchmark results, we construct a matrix, F, for all pairs of opcodes, which indicates the frequency with which they are executed consecutively:

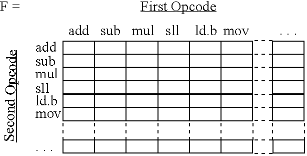

We aim to choose a mapping, M, from a bit pattern to the opcode that it will represent:

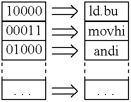

When selecting this mapping, we attempt to minimise the following summation:

$${\sum }_{i = 0 , j = 0}^{i = ( n - 1 ) , j = ( n - 1 )} H ( i , j ) F ( M [ i ] , M [ j ] ) \qquad Formula 1$$

Where H(i,j) is the Hamming distance between bit patterns i and j, M[i] and M[j] are the opcodes assigned to bit patterns i and j respectively, F(a, b) is the frequency with which opcodes a and b are executed consecutively, and there are ‘n’ possible bit patterns that can be used to represent the opcodes. Note that not every bit pattern has to represent an opcode, in which case F(M[i], M[j]) is zero.

Various methods are possible to optimise this in order to minimise the overall Hamming distance. An exhaustive search may be possible when there are small numbers of bit patterns. Otherwise, a heuristic based minimisation algorithm can be used; for example simulated annealing or a genetic algorithm.

Next we consider optimisations relating to the secondary opcode bit patterns.

From the illustration of the three typical instruction formats given above, it can be seen that the secondary opcode field may be adjacent to an immediate value in addition to other secondary opcode fields.

In the simplest algorithm, benchmark data is used to measure the frequency with which each of the secondary opcodes occurs. The most common secondary opcodes are then assigned bit patterns that are close in terms of Hamming Distance to zero. This assumes immediate value bit patterns tend to contain mostly zeros.

A better method exists that takes the actual values of the immediate value bit patterns into account. We again construct a matrix of adjacent fields, but also include all of the possible immediate values that are adjacent to the secondary opcode fields, along with the frequency that they occur:

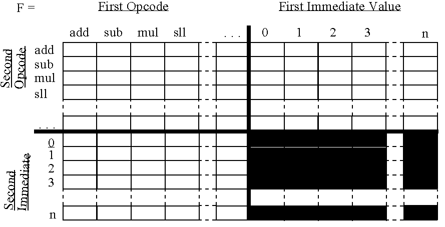

The bottom right quadrant of this matrix represents the frequency of consecutive immediate values, the optimisation of which is discussed in a separate patent application.

Given:
A set, O, of n opcodes, O₀, O₁ . . . Oₙ₋₁, representing the operations performed by the processor e.g. add, mul, sub, etc.
A set, I, of the 2^{m} integers to be represented by an m-bit long immediate value. These numbers may be in the range 0 to 2^{m}−1, or the range −2^{(m-1)} to 2^{(m-1)}−1, or some other range depending on the chosen number representation.
A set, P, of all 2^{m} possible m-bit long bit patterns, P₀, P₁ . . . P₍₂_{^{m}}₋₁₎.

Let:
Set S be the union of O and I, representing all the possible meanings of the instruction bits in question.
H(x, y), for all xεP and yεP, be the Hamming Distance between the bit patterns x and y.

By simulation, or otherwise, we determine:
F(a, b), for all aεS and bεS. This is the frequency (or an estimate of the frequency) with which a is followed by b in consecutive instructions. For example, F(O₁, 4) is the frequency (or an estimate) with which one instruction contains secondary opcode O₁ and the next instruction contains the immediate value 4, occupying the same bits. Similarly, F(O₃, O₈) is the frequency (or an estimate) with which secondary opcode O₈ follows secondary opcode O₃.

We aim to find an optimal mapping, M(a)=x, for aεS and xεP, that maps between an opcode, or an immediate value, and the bit pattern that is used to represent it. For example, M(O₁)=P₂₃ would indicate that bit pattern P₂₃ has been allocated to opcode O₁. For immediate values (aεI), the mapping defines the number representation in use, e.g. binary, two's complement binary, Gray code, sign magnitude, etc.

We find a permutation of the mapping function for the instruction opcodes (i.e. M(a), for all aεO) such that the following expression is minimized:

$${\sum }_{a ∈ S} {\sum }_{b ∈ S} H ( M ( a ) , M ( b ) ) F ( a , b ) \qquad Formula 2$$

Once again, the optimization process can use any of the standard techniques such as an exhaustive search, or a heuristic method such as simulated annealing or using a genetic algorithm.

Although the above method has been described for secondary opcodes that may be intermixed with immediate values, it is also applicable to other control codes in an instruction. For example the codes that specify the registers to be used by each of the operations may also be aligned with each other, or with parts of an immediate value, and therefore may also be optimized using the techniques described.

More generally still, this invention may also be applied to any other environment where a data stream contains a number of aligned elements, some of which have a fixed bit pattern representation while others can be modified.

1-15. (canceled)

16. A method of reducing the power consumption of a microprocessor system which comprises a microprocessor and a memory connected by at least one bus, the microprocessor being arranged to execute a program stored in said memory,
wherein said program comprises a series of instructions each represented by a number of bits, said instructions contain a plurality of control codes, each control code represents an action to be carried out by the microprocessor, and each control code is represented by a bit pattern corresponding to that control code,
the method comprising:
determining the frequency with which each control code occurs, or is likely to occur, adjacent to each of the other control codes in adjacent instructions of said program, and
based on the frequencies so determined in the previous step, assigning a bit pattern to each control code which minimizes the average hamming distance between consecutive instructions when the program is run.

17. A method as claimed in claim 16, wherein at least some of said control codes are operation codes, which represent basic actions which the processor should carry out.

18. A method as claimed in claim 16, wherein at least some of said control codes are register specifiers.

19. A method as claimed in claim 16, wherein at least some instructions contain a primary control code which always occupies the same bit position within the instruction.

20. A method as claimed in claim 19, wherein the average hamming distance between instructions is minimized by:
determining the hamming distance between each pair of primary control codes, determining the frequency with which each primary control code occurs, or is likely to occur, adjacent to each other primary control code, and
assigning bit patterns to said primary control codes so that the sum, over all primary control codes, of the hamming distance between pairs of primary control codes weighted by said frequency for each pair of primary control codes, is minimized.

21. A method as claimed in claim 19, wherein the average hamming distance between pairs of primary control codes is minimized by minimizing the summation of Formula 1 referred to herein.

22. A method as claimed in claim 16, wherein at least some instructions contain a secondary control code which may be positioned coincident with, or at least partially overlap with, another secondary control code, or an immediate value, in an adjacent instruction.

23. A method as claimed in claim 22, wherein minimization of the average hamming distance between consecutive instructions takes into account the hamming distance between secondary control codes in adjacent instructions.

24. A method as claimed in claim 22, wherein minimization of the average hamming distance between consecutive instructions takes into account the hamming distance between secondary control codes and immediate values in adjacent instructions.

25. A method as claimed in claim 24, which further includes the following steps:
determining the frequency with which each secondary control code occurs, or is likely to occur, in said program,
assigning bit patterns to the secondary control codes in such a way that those secondary control codes which occur more frequently are assigned bit patterns which are closer, in terms of their hamming distance, to zero.

26. A method as claimed in claim 24, wherein minimization of the average hamming distance between consecutive instructions includes assigning bit patterns to secondary control codes so as to minimize the summation given in Formula 2 referred to herein.

27. A method as claimed in claim 16, wherein all control codes referred to in the method are operation codes, and all references to primary and secondary control codes are to primary and secondary operation codes respectively.

28. A method as claimed in claim 16, wherein all control codes referred to in the method are register specifiers, and all references to primary and secondary control codes are to primary and secondary register specifiers respectively, secondary register specifiers being register specifiers which may be positioned adjacent to, or at least overlap with, another secondary register specifier, or an immediate value, in an adjacent instruction.

29. A program for reducing the power consumption of a microprocessor system, wherein bit patterns of control codes used in the program have been optimized in accordance with the steps of any preceding claim.

30. A reduced power microprocessor system comprising a microprocessor and a memory connected by at least one bus, wherein said memory contains a program as claimed in claim 29 for execution by said microprocessor.
